(19) United States
(12) Patent Application Publication
(10) Pub. No.: US 2026/0197797 A1
(43) Pub. Date: Jul. 9, 2026

(54) NETWORK CONNECTION INFORMATION BASED ON EXPECTED DEVICE LOCATION

(71) Applicant: Apple Inc., Cupertino, CA (US)

(72) Inventors: Raghuveer MALLIKARJUNAN, Sunnyvale, CA (US); Erdogan DEDE, San Diego, CA (US); Muthukumaran DHANAPAL, San Diego, CA (US)

(21) Appl. No.: 19/015,628

(22) Filed: Jan. 9, 2025

(51) Int. Cl. H04W 64/00; H04B 17/391; H04W 24/02

(52) U.S. Cl. CPC H04W 64/006; H04B 17/3913; H04W 24/02

(57) ABSTRACT

The subject technology provides for configuring an electronic device for connecting to a cellular base station at an expected location. For example, a first device determines an expected location of a second device at a second time. The first device then identifies cellular connection information for connecting to a cellular base station at the expected location of the second device at the second time and transmits the cellular connection information to the second device for connecting to the cellular base station at the expected location.

### TECHNICAL FIELD

This disclosure relates generally to network connectivity of electronic devices.

### BACKGROUND

The use of electronic devices such as smartphones, tablets, and wearable devices like smartwatches have seen a significant rise. These devices offer convenience, connectivity, and a wide range of functionalities, from communication and fitness tracking to navigation and entertainment. However, some of these devices, due to their compact size and design, often comes with limited wireless communication. Recognizing and providing support for devices with relatively limited wireless communication capabilities is essential as these devices become more integrated into daily routines.

### BRIEF DESCRIPTION OF THE DRAWINGS

Certain features of the subject technology are set forth in the appended claims. However, for the purpose of explanation, several aspects of the subject technology are set forth in the following figures.

FIG. 1 illustrates an example network environment according to aspects of the subject technology.

FIG. 2 illustrates an example computing architecture for a system implementing a virtual computing environment according to aspects of the subject technology.

FIG. 3 illustrates an example scenario according to aspects of the subject technology.

FIG. 4 illustrates a flowchart according to aspects of the subject technology.

FIG. 5 illustrates a flowchart according to aspects of the subject technology.

FIG. 6 illustrates an example electronic system with which aspects of the subject technology may be implemented in accordance with one or more implementations.

The details above in the Brief Description of the Drawings are intended to describe only some aspects relating to certain embodiments of the innovations herein and should not be deemed in any way limiting with respect to requiring or omitting any aspect for embodiments to be claimed or otherwise limiting the disclosure or embodiments keeping with its scope or spirit.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In some implementations, structures and components are shown in block diagram form to avoid obscuring the concepts of the subject technology.

Electronic devices such as smartwatches with cellular connectivity have transformed the way users interact with technology. These devices enable users to stay connected without the need to carry a smartphone constantly, which has proven useful in situations where carrying a smartphone is impractical or inconvenient, like during workouts, outdoor activities, or quick errands. With cellular connectivity, users can make and receive calls, send messages, and access Internet based services directly from their smartwatches, creating a seamless and efficient communication experience. Beyond communication, cellular enabled smartwatches also support essential services like Global Positioning System (GPS) navigation, health monitoring, music streaming, mobile payments, etc., enhancing their standalone functionality.

However, electronic devices with a smaller form factor such as smartwatches face several challenges with cellular connectivity, including limited signal strength, compatibility with fewer cellular frequency bands, and limited battery. The cellular signal reception in smartwatches is limited due to the compact size of the device, which restricts the space available for essential components like antennas. Unlike smartphones, which can house larger and more sophisticated antennas designed to capture a wide range of frequencies, smartwatches have smaller, often simplified antennas that struggle to match the reception quality like smartphones. This limitation effects the watch's ability to maintain a stable connection in areas with weaker network coverage, such as rural locations, buildings with thick walls, or underground spaces. As a result, users may experience dropped calls, slower data speeds, and inconsistent connectivity when relying on smartwatches cellular capabilities in less than ideal network conditions. Smartwatches face further limitations due to the limited ability to operate on multiple cellular frequency bands effectively. Unlike smartphones which have sophisticated antenna systems that support a wide range of frequencies (including low, mid, and high bands) smartwatches can only work with a subset of the available frequencies. In addition, smaller batteries of smartwatches can quickly drain due to cellular functions that a smartwatch may have to perform to try out different cellular frequencies and cell base stations for optimal cellular connectivity.

To overcome such a situation, the subject technology enables smartphones to use historical user behavior and contextual information associated with the user to determine when the user typically does not carry their smartphone and instead depends on their smartwatch for cellular connectivity. For instance, the smartwatch can anticipate that the user will engage in outdoor activities at the specific time and location. Additionally, the subject technology allows the smartphone to identify cellular base stations and cellular frequency bands that are compatible with the smartwatch and offer an optimal cellular connection for the smartwatch at that specific time and location when relied upon for connectivity. The subject technology further allows the smartphones to provide the smartwatch with connection information to connect to the different base stations and cellular frequencies while the smartwatch is connected to the smartphone.

The subject technology offers several advantages in improving the reliability and user experience of smartwatch cellular connectivity. By analyzing historical user patterns and contextual data, the system can predict when the user is likely to rely solely on the smartwatch, enabling it to prepare in advance for standalone connectivity. This predictive capability allows the smartwatch to be configured beforehand for maintaining communication and providing cellular services even when the smartphone is left behind. Such functionality is useful for activities when carrying a smartphone is inconvenient, such as running, hiking, or outdoor pursuits. Another key advantage of this technology is the ability to enhance connection stability and efficiency by configuring the smartwatch to use the optimal cellular frequency compatible with the limited hardware. Smartwatches typically have smaller antennas and limited battery capacity, making them more prone to connectivity issues. By proactively setting the smartwatch to connect to preselected, reliable cellular frequencies, the technology reduces the likelihood of dropped signals and inefficient connections. In contrast, without this subject technology, the smartwatch would just camp on the last used cellular frequency even when it's not optimal. This approach improves the smartwatches performance during standalone use, ensuring that the users experience optimal cellular connectivity and efficient battery usage even in challenging network environments.

The subject technology further improves the device's power consumption as it increases its connection reliability, making it a more viable communication tool in diverse environments. For example, the subject technology helps conserve battery power in smartwatches by reducing unnecessary power drain required for frequent attempts to search for signals or switch between different frequency bands. The targeted approach minimizes the amount of power used in signal seeking activities which are typically energy intensive processes. Additionally, by leveraging historical patterns and contextual data, the subject technology enables the smartwatch to anticipate when it will be used in standalone mode and prepare accordingly. This can include switching to power efficient frequency bands or conserve battery power when high connectivity demands are unnecessary. Instead of spending battery power to maintain maximum connectivity, the smartwatch can prioritize low energy modes whenever feasible, allowing it to operate on a single charge.

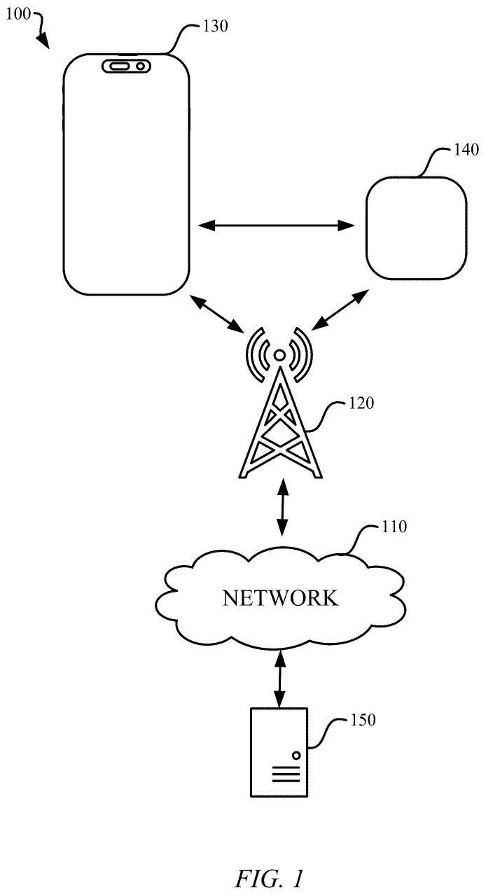

FIG. 1 illustrates an example cellular network environment 100 according to aspects of the subject technology. Not all the depicted components may be used in all implementations, however, and some implementations may include additional or different components than those shown in the figure. Variations in the arrangement and type of the components may be made without departing from the scope of the claims as set forth herein. Additional components, different components, or fewer components may be provided.

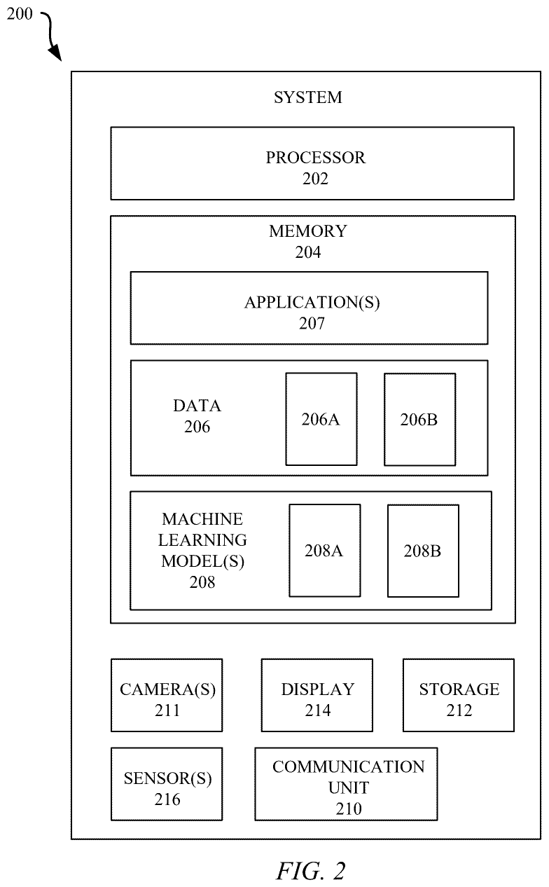

As shown, the network environment 100 includes a cellular base station 120, which communicates over a transmission medium with a first user device 130 as well as a second user device 140. As an example, the first user device 130 can be a smartphone carried by a user, and the second user device 140 can be an accessory device such as a smartwatch worn by that same user. The first user device 130 may be configured to communicate with the second user device 140 using any of various short range communication protocols, such as Bluetooth or Wi-Fi. The second user device 140 device may be any type of wireless device, typically a wearable device that has a smaller form factor, limited battery, and/or limited communications abilities relative to the first user device 130. The network 110 and the cellular base station 120 may communicatively (directly or indirectly) couple the first user device 130, the second user device 140 and a server 150. For explanatory purposes, the network environment 100 is illustrated in FIG. 1 as including the smartphone and the smartwatch; however, the network environment 100 may include any number and type of first and second user devices. For example, the first and second user devices can be a portable computing device such as a laptop computer, a peripheral device (e.g., a digital camera, headphones), a tablet device, a wearable device such as a band, a health monitor and the like. The first user device 130 and the second user device 140 may be, and/or may include all or part of, the systems discussed below with respect to FIG. 2 and/or with respect to FIG. 11.

The server 150 may form all or part of a network of computers or a group of servers, such as in a cloud computing or data center implementation. For example, the server 150 stores data and software, and includes specific hardware (e.g., processors, graphics processors and other specialized or custom processors, such as neural processors) for storing data associated with communication networks. In an implementation, the server 150 may function as a cloud storage server that stores any of the aforementioned content generated by the above-discussed devices and/or the server 150. The server 150 may be, and/or may include all or part of, the systems discussed below with respect to FIG. 2 and/or with respect to FIG. 11.

The first user device 130 and the second user device 140 include cellular communication capability and hence are able to directly communicate with cellular base station 120. However, since the second user device 140 is possibly limited in communication features and/or battery, the second user device 140 may selectively utilize the first user device 130 as a proxy for communication purposes with the base station 120 and hence to the network 110. In other words, the second user device 140 may selectively use the cellular communication capabilities of the first user device 140 to conduct its cellular communications. The limitation on communication abilities of the second user device 140 can be permanent, e.g., due to limitations in output power or the radio access technologies (RATs) supported, or temporary, e.g., due to conditions such as current battery status, inability to access a network, or poor reception.

The first user device 130 and the second user device 140 may be capable of communicating using any of multiple wireless communication technologies. For example, the first user device 130 and the second user device 140 can be configured to communicate using one or more of GSM, UMTS, CDMA2000, WiMAX, LTE, LTE-A, WLAN, Bluetooth, one or more global navigational satellite systems (GNSS, e.g., GPS or GLONASS), one and/or more mobile television broadcasting standards (e.g., ATSC-M/H), etc. Other combinations of wireless communication technologies (including more than two wireless communication technologies) are also possible. Likewise, in some instances the first user device 130 and the second user device 140 may be configured to communicate using only a single wireless communication technology.

The base station 120 may be a base transceiver station (BTS) or cell site, and may include hardware that enables wireless communication with the first user device 130 (e.g., smartphone) and the second user device 140 (e.g., smartwatch.) The base station 120 may also be equipped to communicate with a network 110 (e.g., a core network of a cellular service provider, a telecommunication network such as a public switched telephone network (PSTN), and/or the Internet, among other possibilities). Thus, the base station 120 may facilitate communication among the first user device 130 (e.g., smartphone), the second user device 140 (e.g., smartwatch) and the network 100. The base station 120 may also facilitate communication between the first the first user device 130 and the second user device 140. In other implementations, base station 120 can be configured to provide communications over one or more other wireless technologies, such as an access point supporting one or more WLAN protocols, such as 802.11 a, b, g, n, ac, ad, and/or ax, or LTE in an unlicensed band (LAA).

The communication area (or coverage area) of the base station 120 may be referred to as a “cell.” The base station 120, the first user device 130 and the second user device 140 may be configured to communicate over the transmission medium using any of various radio access technologies (RATs) or wireless communication technologies, such as GSM, UMTS (WCDMA, TDS-CDMA), LTE, LTE-Advanced (LTE-A), HSPA, 3GPP2 CDMA2000 (e.g., 1xRTT, 1xEV-DO, HRPD, eHRPD), Wi-Fi, WiMAX etc. Base station 120 and other similar base stations (not shown) operating according to one or more cellular communication technologies may thus be provided as a network of cells, which may provide continuous or nearly continuous overlapping service to the user devices over a geographic area via one or more cellular communication technologies.

In some implementations, the first user device 130 and the second user device 140 may provide a framework for training a machine learning model using training data, where the trained machine learning model is subsequently deployed locally at the first user device 130 and/or the second user device 140, respectively. In some implementations, one or more frameworks for training machine learning models may be provided by one or more other user devices that are associated with the same user account as the first user device 130 or the second user device 140. For example, the one or more other user devices may have more processing, memory, and/or power resources for training machine learning models. The one or more other user devices may then securely deploy the trained machine learning models directly on the first user device 130 and/or the second user device 140, e.g., without facilitation from a local or a cloud based server.

In some implementations, the server 150 may provide a platform to securely train one or more machine learning models for secure deployment to a client electronic device (e.g., the first user device 130). The machine learning model deployed on the first user device 130 may then perform one or more machine learning tasks. In some implementations, the server 150 may provide a cloud service that securely utilizes the trained machine learning model and continually refines the machine learning model over time. The server 150 may be, and/or may include all or part of, the system discussed below with respect to FIG. 2 and/or with respect to FIG. 11.

FIG. 2 illustrates an example system 200 in accordance with some implementations of the subject technology. In an example, the system 200 may be implemented in the first user device 130 or the server 150. In another example, the system 200 may be implemented either in a single device or in a distributed manner in a plurality of devices, the implementation of which would be apparent to a person skilled in the art.

In an example, the system 200 may include a processor 202, memory 204 (memory device) and a communication unit 210. The memory 204 may store data 206 and one or more machine learning models 208A-B. In an example, the system 200 may include or may be communicatively coupled with a storage 212. Thus, the storage 212 may be either an internal storage or an external storage. In the example of FIG. 2, the system 200 includes one or more camera(s) 211, a display 214, and one or more sensors(s) 216. Sensor(s) 216 may include location sensors (e.g., satellite positioning system sensors), motion sensors (e.g., inertial sensors), and/or depth sensors (e.g., stereo cameras, LIDAR sensors, radar sensors, time-of-flight sensors, or the like).

In an example, the processor 202 may be a single processing unit or multiple processing units. The processor 202 may be implemented as one or more microprocessors, microcomputers, microcontrollers, digital signal processors, central processing units (CPUs), graphics processing units (GPUs), neural processors, specialized processors, e.g., for training and/or evaluating machine learning models, such as large language models, state machines, logic circuitries, and/or any devices that manipulate signals based on operational instructions. Among other capabilities, the processor 202 is configured to fetch and execute computer-readable instructions and data stored in the memory 204.

The memory 204 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The memory 204 may include one or more applications 207 that can be executed, and/or are currently being executed, on the system 200, such as a messaging application or generally any application. The one or more applications 207 can interact with each other or with an operating system of the system 200 using application programming interfaces (API) to send or receive data. The one or more applications 207 can also include respective user interfaces (UI) to facilitate user-interaction, enabling the user to provide inputs and receive output seamlessly.

The data 206 may represent, amongst other things, a repository of data processed, received, and generated by one or more processors such as the processor 202. Data 206 can also include contextual data 206A associated with the user of the first user device 130 (or the second user device 140). The contextual data 206A can include information collected from a profile of the user, and/or collected from native and/or third-party applications executing on the user's devices and/or the server 150. Data 206 may also include network data 206B associated with cellular networks to which the first user device 130 was connected in the past. For example, the network data can include cellular network properties observed by the first user device 130 like signal strength, cellular network type (e.g., 2G, 3G, 4G, 5G, etc.,) frequency bands in use, signal quality per frequency band, etc. The contextual data 206A and network data 206B is described later in the specification in detail. The contextual data 206A and the network data 206B can also be stored in the storage 212 if not used actively in training machine learning model(s). However, while training machine learning model(s), the processor 202 can retrieve the contextual data 206A and the network data 206B from the storage 212. One or more of the aforementioned components of the system 200 may send or receive data, for example, using one or more input/output ports and one or more communication units.

The machine learning model(s) 208, in an example, may include one or more of machine learning (ML) based models and artificial intelligence-based models, such as, for example, a first ML model 208A and a second ML model 208B, or any other models and/or machine learning architectures. The first ML model 208A can be implemented on the first user device 130 and/or the server 150 and can be trained using training data (e.g., included in the contextual data 206A or other data) to predict when the user is likely to solely depend on the second user device 140 for cellular connectivity. For example, the first ML model 208A can be implemented on a first user device 130 (e.g., a smartphone) to predict an estimated location and time, when the second user device 140 (e.g., a smartwatch) will not be in the vicinity of the first user device 130 and hence not be connected to the first user device 130 using short range communication protocols, such as Bluetooth or Wi-Fi. As an example, the first ML model 208A can determine a likelihood that the user may go for a hike to an estimated location after three hours and during the hike, the user will not be carrying the user's smartphone, but the user will be wearing the smartwatch.

In response to determining that the user is likely to depend on the second user device 140 for cellular connectivity within a threshold amount of time of the current time (e.g., within 2 hours, 4 hours, 8 hours, 24 hours, or any number of hours), the first user device 130 can use the second ML model 208B to predict a set of cellular frequency bands for connecting to the base station 120 covering the estimated location that can provide optimal cellular connectivity (e.g., high data transfer, less network congestion, etc.,) for the smartwatch. Depending on the estimated location and the time when the user will be present at the estimated location, the second ML model 208B can also predict one or more base stations 120 and a respective set of cellular frequencies for connecting to each of the one or more base stations 120 for optimal cellular connectivity. For example, the second ML model 208B can predict a respective set of frequencies for connecting to the base station 120 of the immediate cell covering the estimated location and the base stations 120 of nearby cells. The second ML model 208B can be implemented on the first user device 130 and/or the server 150 and can be trained using training data (e.g., data included in the network data 206B or other data.) The prediction and the training of the first ML model 208A and the second ML model 208B may be implemented by the processor 202 for performing one or more of the operations, as described herein.

In an example, the communication unit 210 may include one or more hardware units that support wired or wireless communication between the processor 202 and processors of other computing devices.

In some implementations, the first ML model 208A is a neural network designed using a transformer architecture and trained to predict scenarios when the user is likely to rely solely on the second user device 140 for cellular connectivity. During a designated first time (e.g., any time prior to when the user is likely to rely solely on the second user deice 140) the first ML model 208A can analyze the user's behavior patterns and contextual data to estimate both the location and a second time (e.g., any time when the user is likely to rely solely on the second user deice 140) when the user will not carry the first user device 140. For instance, the first ML model 208A can process the historical activity data and contextual information to predict that the user will go for jogging at an estimated location during a second time.

In some implementations, contextual information associated with the user can include information from one or more user profiles. For example, the user can have a user profile for accessing social media on the first user device 130. These user profiles can include contextual information such as user interest, likes, dislikes and social interactions. For example, the user can login to the user's social media account using an application such a browser and express interest in an event (e.g., a 5 k marathon) and confirm the user's attendance at a particular time and location. In some implementations, these user profiles are stored in the storage 212 of the first user device 130. In such implementations, the processor can retrieve contextual information associated with the user from the storage 212.

In some implementations, contextual information associated with the user can include information from one or more native or third-party applications. For example, contextual information from the calendar application can include information related to the user's schedule, preferences, and routines. Information from calendar application can also include information regarding upcoming events, meetings, meeting locations, activity types, event duration etc. Additionally, contextual information from calendar application can reveal patterns over time, like recurring events (e.g., daily workouts or weekly business trips) that further provide deep insights into the user's behavior and patterns exhibited by the user. As for another example, the user can have a user profile on applications such as fitness applications, messaging applications, navigation applications, etc. Contextual information from such applications can provide context that indicate the user's likely behavior or connectivity needs. For example, location data from navigation application can provide insights into the user's travel patterns, frequent destinations, and current activity (such as walking, driving, or cycling) which can help predict when the user might rely on the second user device 140 for cellular connectivity. Similarly, data from fitness applications might reveal workout routines, times, and locations, indicating when the user is likely to be active and away from the first user device 130.

In some implementations, contextual data associated with the user can be fed to the first ML model 208A. The first ML model 208A can include one or more learning-based and/or non-learning-based models for perceiving, synthesizing, and inferring information. Persons skilled in the art will appreciate that the first ML model 208A can include any suitable number of processes to predict an estimated location and a second time when the second user device 140 (e.g., a smartwatch) would not be in the vicinity of the first user device 130 (e.g., a smartphone) and hence not connected to the first user device 130.

Persons of ordinary skill in the art will appreciate that first ML model 208A can include any suitable machine learning models that are well-known or widely available such as regression techniques, classification techniques, neural networks, and deep learning networks. In instances where first ML model 208A comprises a machine-learning based model, first ML model 208A can be trained to predict an estimated location and a second time when the second user device 140 (e.g., a smartwatch) would not be in the vicinity of the first user device 130 (e.g., a smartphone) using one or more well-known or widely available training techniques such as supervised learning, semi-supervised learning, unsupervised learning, and/or reinforcement learning techniques. The training data can include the aforementioned contextual data 206A.

To train the first ML model 208A, the processor 202 of the system 200 of the first user device 130 can select historical contextual information associated with user, the user's location at different times and an indication of whether the user was carrying the first user device 130 for generating a training dataset. For brevity, this dataset is referred to as the first training dataset. In some implementations, the first training dataset can also include respective locations (e.g., GPS co-ordinates, connected base tower identification code (BSIC), etc.,) of the first user device 130 and the second user device 140. The training objective of the first ML model 208A can include computing a loss value to ensure that the predicted locations of the first user device 130 and the second user device 140 (or the user) at specific time matches the actual location of the first user device 130 and the second user device 140. The training also includes providing feedback to the first ML model 208A. The training can further include fine tuning that involves adjusting hyperparameters, extending the training duration or enriching the training data set with more diverse examples.

In some implementations, the system 200 of the first user device 130 may continuously monitor its cellular network connectivity and record one or more network characteristics and performance attributes of the cellular network. For example, the first user device 130 can monitor and record the primary frequency band of the cellular network. For example, in North America, the 850 MHz band is often considered the primary frequency for GSM networks, while 1900 MHz is another important frequency depending on location and carrier. The first user device 130 can also monitor one or more secondary frequencies that are often used in conjunction with the primary band to increase data throughput through a technique called “carrier aggregation,” where multiple frequencies are combined to transmit data simultaneously. In some implementations, the second user device 140 can also monitor its cellular network connectivity and record the one or more network characteristics and performance attributes of the cellular network as the user may not carry the first user device 130 to locations where the user may carry only the second user device 140. For example, the user may not carry the smartphone during a hike but may wear the smartwatch.

In addition, the first user device 130 can monitor transitions between different cellular frequencies (e.g., moving from a low to high frequency band) while the user carrying the first user device 130, moves from one geographical location to another. The first user device 130 can also monitor the availability and connectivity of cellular frequencies from the immediate cell base station 120 or nearby cell base stations 120. The first user device 130 can further monitor the type of cellular network (e.g., LTE, 5G NR) that is associated with each cellular frequency to evaluate the range of supported services and identify gaps in high-speed cellular network connectivity.

In some implementations, the first user device 130 can also determine one or more performance attributes of the cellular network to which the first user device 130 is connected. For example, the first user device 130 can enter into a “Field Test Mode” thereby obtaining information about the signal strength of the cellular frequency currently being used to connect to the cell base station 120, and the congestion on the connected frequency band and on the base station 120. As for another example, the first user device 130 can further obtain signal quality indicators such as Signal-to-Interference-plus-Noise Ratio (SINR) or Reference Signal Received Power (RSRQ) of each cellular frequency band in use.

In some implementations, the first user device 130 can switch between cellular frequencies to obtain more information about the cellular network by systematically shifting the cellular connection between different frequency bands. By doing so, the first user device 130 can collect information on network performance, coverage quality, and signal reliability across each frequency and across multiple base stations 120. In some implementations, the first user device 130 can also monitor the time and location of the first user device 130 thereby corelating the geographical location (e.g., GPS co-ordinates, BSIC of the connected or any nearby base station 120, etc.,) and the cellular connectivity at the geographical location at different times.

In some implementations, the first user device 130 can also monitor various cellular network cells and their respective cellular frequencies to gather detailed insights into the cellular environment. For example, first user device 130 can record information about the frequency bands used by nearby network cells, as well as the specific frequency bands emitted by their respective base stations 120. Additionally, it can track performance attributes such as network congestion levels, SINR, RSRQ, and other key metrics that influence the network performance of the nearby cell base stations 120.

In some situations, where the first user device 130 is configured to use two or more cellular connections (e.g., smartphones with more than one Subscriber Identity Module (SIM), etc.,) the system 200 of the first user device 130 can switch cellular connections between different cellular networks to obtain information about different cellular networks that may be operating in the same geographical area. For example, if the first user device 130 have two SIMs to connect to cellular network A and cellular network B, the first user device 130 can use the first SIM to connect to the cellular network A and obtain the previously described network characteristics and performance attributes of the cellular network A. The first user device 130 can then switch to the second SIM to connect to the cellular network B and obtain the previously described network characteristics and performance attributes of the cellular network B. In another implementation, and depending on the configuration of the first user device 130, the first user device 130 can simultaneously connect cellular networks A and B and simultaneously obtain the previously described network characteristics and performance attributes of the cellular network A and B.

In some embodiments, the first user device 130 can further obtain information about the cellular network(s) from the server 150. For example, multiple first user devices 130 can store information about the cellular networks in different geographical areas in the server 150, creating a repository of network information. The stored network information can include details about network congestion, signal strength, availability of frequency bands, SINR, RSRQ, etc., which the server 150 can then provide to connected devices as needed.

In some implementations, the first user device 130 can use the previously described network characteristics and performance attributes to create a second training dataset so as to train the second ML model 208B to predict a set of cellular frequencies as a recommendation for the second user device 140. To create the second training dataset, the second user device 130 can only select network characteristics and performance attributes of cellular frequencies that are compatible with the second user device 140 so as to ensure that the predicted set of cellular frequencies can be used by the second user device 140. For example, if the recorded data includes network characteristics and performance attributes of 800 unique cellular frequencies of which only 300 cellular frequencies are compatible with the second user device 140, the first user device 130 would select the 300 cellular frequencies for generating the second training dataset.

In some implementations, the estimated location and the second time predicted by the first ML model 208A can be fed to the second ML model 208B. The second ML model 208B can include one or more learning-based and/or non-learning-based models for perceiving, synthesizing, and inferring information. Persons skilled in the art will appreciate that the second ML model 208B can include any suitable number of processes to predict base stations 120 and sets of cellular frequency bands which can provide optimal cellular connectivity based on the input data.

Persons of ordinary skill in the art will appreciate that second ML model 208B can include any suitable machine learning models that are well-known or widely available such as regression techniques, classification techniques, neural networks, and deep learning networks. In instances where second ML model 208B comprises a machine-learning based model, second ML model 208B can be trained to predict base stations 120 and sets of cellular frequency bands based on the estimated location and the second time predicted by the first ML model 208A using one or more well-known or widely available training techniques such as supervised learning, semi-supervised learning, unsupervised learning, and/or reinforcement learning techniques. The training data can include the aforementioned network data.

In some implementations, the second ML model 208B can be a neural network designed using a transformer architecture that can predict a set of cellular frequencies which when used by the second user device 140 to connect to the cellular network, provide optimal quality cellular connectivity. For example, assume that the base station emits 300 frequencies that are compatible with the second user device 140. These 300 cellular frequencies can correspond to 150 full duplex channels. The second ML model 208B can predict a set (e.g., 40 frequencies which correspond to 20 full duplex channels) of cellular frequencies which would allow optimal cellular connectivity with the second user device 140 at the estimated location and at the second time. For example, during the first time, the second ML model 208B can predict a performance of each of the cellular frequencies present in the estimated location during the second time and select a set of cellular frequencies having optimal cellular connectivity. The training objective of the second ML model 208B can include computing a loss value to ensure that the predicted performance of the cellular frequencies is comparable to the actual performances recorded by the first user device 130. The training may also include providing feedback to the second ML model 208B. The training can further include fine tuning that involves adjusting hyperparameters, extending the training duration or enriching the training data set with more diverse examples. As an example, the second ML model 208B can be trained to predict a cellular data transfer rate, network congestion, SINR, RSRQ, etc., or a combination of one or more cellular quality metrics of the cellular frequencies present in the estimated location during the second time.

After training the first ML model 208A, the system 200 of the first user device 130 can determine at the first time (e.g., current time), an expected location of the second user device 140 at the second time (e.g., any time in the future.) In other words, the first user device 130 can determine when the second user device 140 will not be in the vicinity of the first user device 130 and hence not be connected to the first user device 130 using short range communication protocols. For example, during the first time, the system 200 of the first user device 130 can obtain contextual information associated with the user. As described earlier, contextual information can include information from one or more user profiles, one or more third party or native applications, etc. The system 200 of the user device 130 can process the contextual information using the first ML model 208A to determine the expected location of the second user device 140 during the second time. For example, the system 200 of the user device 130 can process the user's workout schedule obtained from a fitness application and user's historical locations from the navigation applications using the first ML model 208A to determine that the user may go for a run after three hours to an estimated location, where the user and may not be carrying the user's smartphone and would be dependent on the second user device 140 for cellular communication.

After determining the estimated location and the second time, the system 200 of the first user device 130 can process the estimated location and the second time using the second ML model 208B to predict a set of cellular frequencies likely to be in use by the base station 120 at the estimated location for cellular connectivity. It should be noted that the base station 120 can be the base station 120 serving the cell covering the estimated location, or any nearby base station 120 from overlapping cells. By considering multiple base stations with potential overlapping coverage the model increases the likelihood of finding the best cellular frequencies to maximize connectivity.

In some implementations, after predicting the cells and the set of cellular frequencies, the system 200 of the first user device 130 can provide a recommendation to the second user device 140, detailing the recommended cells and the cellular frequencies, providing instructions to establish cellular connectivity. For example, the recommendation can include a set of cellular frequencies emitted by the immediate cell base 120 covering the estimated location. As for another example, the recommendation can include a list of cells and respective set of cellular frequencies for each cell in the list of cells. In some implementations, the first user device 130 can transmit these instructions to the second user device 140 while the second user device 140 is still communicatively connected to the first user device 130 via short range communication protocols.

In some implementations, if the first user device 130 fails to transmit the recommendation to the second user device 140 via short range communication protocols, the first user device 130 can relay the recommendation via cellular connectivity. For example, the first user device 130 can upload the recommendation to the server 150 for synchronizing with the second user device 140. When the second user device 140 is connected to the server 150 via any of the cellular frequencies of the cellular network or Wi-Fi hotspot, etc., the second user device 140 can download the recommendation from the server 150. In some implementation, and in response to receiving the recommendation from the first user device 130, the second user device 140 can select a cellular frequency from the set of cellular frequencies and establish cellular connectivity with the base station 120. In other implementations, the second user device 140 can cycle through the set of cellular frequencies to select a cellular frequency that provides optimal cellular connectivity.

In some implementations, the system 200 of the first user device 130 can be further configured to refine the set of cellular frequencies generated by the second ML model 208B, to further optimize the network connectivity and the functioning of the second user device 140. For example, the system 200 of the second ML model 208B can filter a subset from the set of cellular frequencies, based on their predicted and/or historical performances. For example, if the second ML model 208B predicts a set of 40 cellular frequencies for the second user device 140, but the first user device 130 is configured to recommend only 20 cellular frequencies, the system 200 can narrow down the list of frequencies by prioritizing frequencies that have historically provided the highest data throughput. As for another example, the system 200 can select 20 cellular frequencies that can provide connectivity for longer distances. Additionally, the frequency refinement process can prioritize energy efficiency to extend the battery life of the second user device 140. For example, the system 200 of the first user device 130 may filter the set of cellular frequencies to select those that consume less power, providing a balance between signal strength, energy consumption and network congestion as predicted by the second ML model 208B at the estimated location and during the second time. After selecting the subset of cellular frequencies, the system 200 of the first user device 130 can provide a recommendation to the second user device 140, detailing the recommended cellular frequencies and providing instructions to establish cellular connectivity using the recommended cellular frequencies.

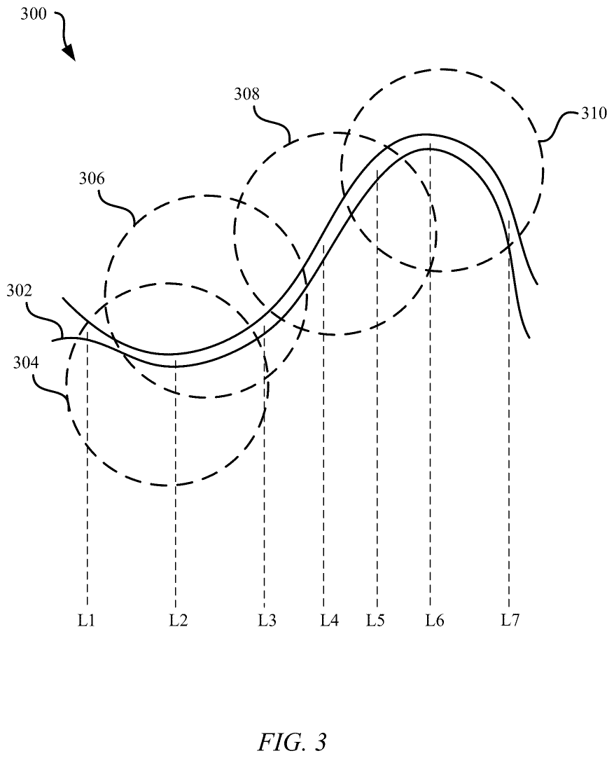

In some implementations, the system 200 of the first user device 130 can use the first ML model 208A to predict multiple estimated locations for the second user device 140 during a period of time. For example, the first ML model 208A can predict a list of estimated locations, each paired with the respective second time that represents the predicted time at each location. For example, the first ML model 208A can determine that the user might go for a run. In response, the first ML model 208A can generate a sequence of estimated locations along the expected route of the user's run, with each estimated location indicating a location the user is likely to pass during the activity. For each location in this list, the first ML model 208A can associate a second time, specifying when the user is expected to be of the spot. In such implementations, the system 200 of the first user device 130 can use the second ML model 208B to predict a sequence of cellular cells and for each cell a set of cellular frequencies for each estimated location in the list. The first user device 130 can then provide a recommendation of the cells and the respective cellular frequencies for each of those estimated locations to the second user device 140 prior to the second time. This is further explained with reference to FIG. 3.

FIG. 3 illustrates an example where the first ML model 208A predicts multiple estimated locations for the second user device 140 during a period of time. FIG. 3 shows a route 302 predicted by the first ML model 208A that the user can take while going for a run. The route 302 includes multiple estimated locations L1-L7. To generate a recommendation for the second user device 140, the system 200 of the first user device 130 can process each of the multiple estimated locations L1-L7 and the associated second time for each of the locations L1-L7 using the second ML model 208B to predict a set of cells and a set of cellular frequencies for the second user device 140. For example, if the predicted location of the user is L1, the second ML model 208B can predict the cell 304 with a set of cellular frequencies emitted by the base station 120 of the cell 304 that can provide optimal cellular connectivity for the second user device 140. However, for the predicted location L2, the second ML model 208B can predict the cells 304 and 306 along with a respective set of cellular frequencies emitted by the respective base stations of cells 304 and 306. Likewise, for the estimated locations L3 and L4, the second ML model 208B can predict the cells 306 and 308 respectively along with a respective set of cellular frequencies emitted by the respective base stations of cells 306 and 308. Similarly, for location L5, the second ML model 208B can predict the cell 308 and 310 along with a respective set of cellular frequencies emitted by the respective base stations of cells 308 and 310. Similarly, for the estimated locations L6 and L7, the second ML model 208B can predict the cell 310 and a set of cellular frequencies emitted by the base station 120 of the cell 310.

In other implementations, instead of predicting discrete estimated locations with specific timestamps, the first ML model 208A can analyze patterns in user behavior, historical geographic movements, and contextual information to estimate a continuous route the user is likely to follow. This path based prediction can provide a broader and a more flexible view of the users anticipated movement accounting for variations and slight deviations that might occur along the way. In such implementations, the system 200 of the first user device 130 can use the second ML model 208B to predict a set of cells and set of cellular frequencies in the predicted path of the user. In such implementations, the first ML model 208A may also predict markers (e.g., GPS coordinates, predicted time, etc.,) which when recommended to the second user device 140 can trigger the second user device 140 to switch to a new cell or frequency band for optimal connectivity.

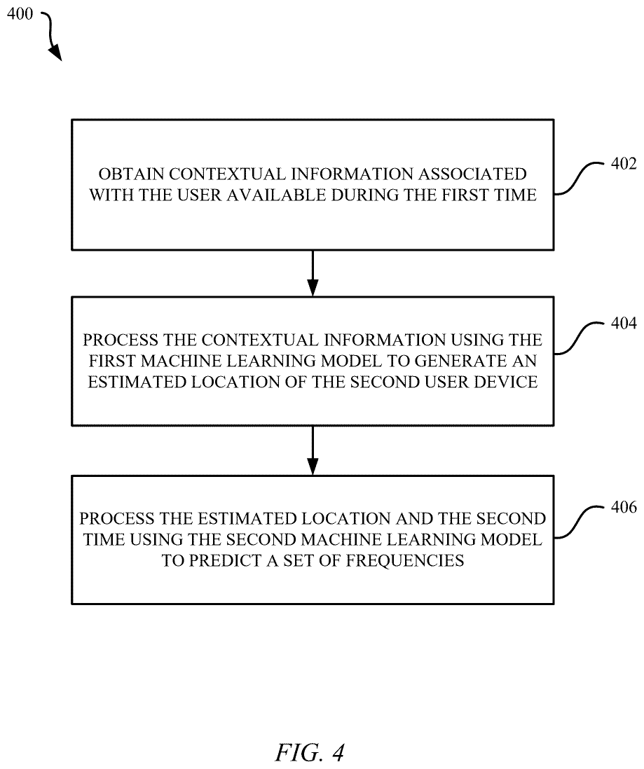

FIG. 4 is a flowchart illustrating an example process 400 for predicting a set of cellular frequencies by the first user device 130. For explanatory purposes, the process 400 is primarily described herein with reference to the first user device 130 and the second user device 140 of FIG. 1. However, the process 400 is not limited to the first user device 130 and the second user device 140 of FIG. 1, and one or more blocks (or operations) of the process 400 may be performed by one or more other suitable devices. Further for explanatory purposes, the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

At block 402, the system 200 of the first user device 130 obtains obtain contextual information associated with the user. Contextual information can include information from one or more user profiles, one or more third party or native applications, etc. For example, the user can have a user profile for accessing social media on the first user device 130. These user profiles can include contextual information such as user interest, likes, dislikes and social interactions. For example, the user can login to the user's social media account using an application such a browser and express interest in an event (e.g., a 5 k run) and confirm the user's attendance at a particular time and location. As for another example, contextual information from the calendar application can include information related to the user's schedule, preferences, and routines. Information from calendar application can include information regarding upcoming events, meetings, meeting locations, activity types, event duration etc.

At block 404, the system 200 of the first user device 130 can use the first ML model 208A to generate an estimated location of the second user device 140 at a second time. For example, the first user device 130 can determine when the second user device 140 will not be in the vicinity of the first user device 130 and hence not be connected to the first user device 130 using short range communication protocols. For example, the system 200 of the user device 130 can process the contextual information using the first ML model 208A to determine the expected located of the second user device 140 during a second time. For example, the system 200 of the user device 130 can process the user's workout schedule obtained from a fitness application and user's historical locations from the navigation applications using the first ML model 208A to determine that the user may go for a run after three hours to an estimated location, where the user will be dependent on the second user device 140 for cellular communication.

At block 406, the system 200 of the first user device 130 can process the estimated location and the second time using the second ML model 208B to predict cellular frequencies that can provide better cellular connectivity for the second user device 140. For example, the system 200 of the first user device 130 can process the estimated location and the second time using the second ML model 208B to predict a set of cellular frequencies likely to be in use at the estimated location for cellular connectivity for optimal cellular connectivity with the base station 120. After predicting the set of cellular frequencies, the system 200 of the first user device 130 can provide a recommendation to the second user device 140, detailing the recommended cellular frequencies and providing instructions to establish cellular connectivity using the recommended cellular frequencies.

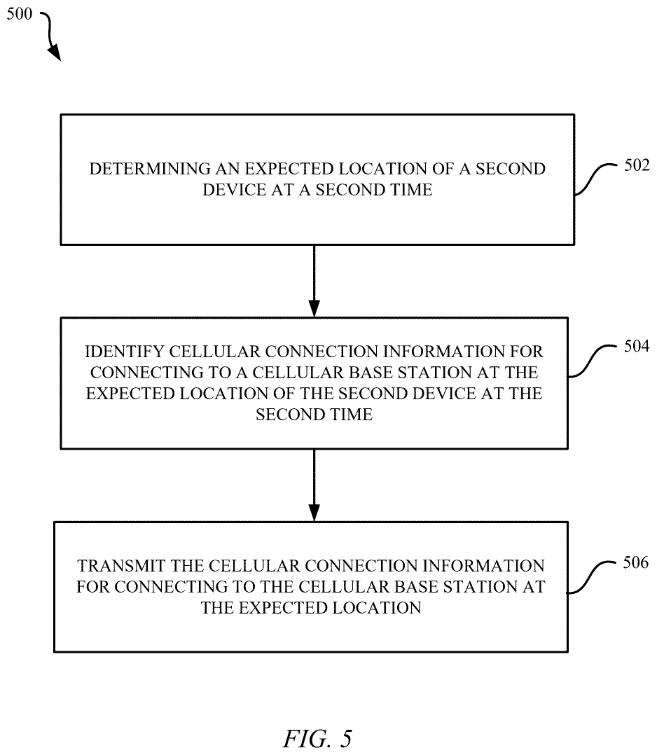

FIG. 5 is a flowchart illustrating an example process 500 for predicting and transmitting cellular connection information to the second user device 140 for connecting to a cellular base station 120 at the expected location of the second device at the second time. For explanatory purposes, the process 500 is primarily described herein with reference to the first user device 130 and the second user device 140 of FIG. 1. However, the process 500 is not limited to the first user device 130 and the second user device 140 of FIG. 1, and one or more blocks (or operations) of the process 500 may be performed by one or more other suitable devices. Further for explanatory purposes, the blocks of the process 400 are described herein as occurring in serial, or linearly. However, multiple blocks of the process 400 may occur in parallel. In addition, the blocks of the process 500 need not be performed in the order shown and/or one or more blocks of the process 500 need not be performed and/or can be replaced by other operations.

At block 502, the first user device 130 determines an expected location of a second user device 140 at a second time. For example, the system 200 of the first user device 130 (e.g., a smartphone) can use the first ML model 208A to predict multiple estimated locations for the second user device 140 (e.g., a smartwatch) during a period of time, such as within a threshold amount of time as the current time. For example, the first ML model 208A can determine that the user might go for a run. In response, the first ML model 208A can generate a list of estimated geographic locations along the expected route of the user's run, with each estimated location indicating a location the user is likely to pass during the activity. In addition, the first ML model 208A can also predict a respective second time that represents the predicted time at each location in the list of estimated locations.

At block 504, the first user device 130 identifies cellular connection information for connecting to a cellular base station at the expected location of the second user device 140 at the second time. For example, after determining the estimated location and the second time, the system 200 of the first user device 130 can process the estimated location and the second time using the second ML model 208B to predict a set of cellular frequencies likely to be in use at the estimated location for cellular connectivity and allow better cellular connectivity with the base station 120. It should be noted that the base station 120 can be the base station 120 serving the cell covering the estimated location, or any nearby base station 120 from overlapping cells.

At block 506, the first user device 130 transmits the cellular connection information to the second user device 140 for connecting to the cellular base stations at the expected location. For example, after predicting the set of cellular frequencies, the system 200 of the first user device 130 can provide a recommendation to the second user device 140, detailing the recommended cells and cellular frequencies and providing instructions to establish cellular connectivity using the recommended cellular frequencies. In some implementations, the first user device 130 can transmit these instructions to the second user device 140 while the second user device 140 is still communicatively connected to the first user device 130 via short range communication protocols.

If the first user device 130 fails to recommend the second user device 140 via short range communication protocols, the first user device 140 can relay the recommendation via cellular connectivity. For example, the first user device 130 can upload the recommendation to the server 150 for synchronizing with the second user device 140. When the second user device 140 is connected to the server 150 via any of the cellular frequencies of the cellular network, the second user device 140 can download the recommendation from the server 150.

Some embodiments described herein can include use of learning and/or non-learning-based process(es). The use can include collecting, pre-processing, encoding, labeling, organizing, analyzing, recommending and/or generating data. Entities that collect, share, and/or otherwise utilize user data should provide transparency and/or obtain user consent when collecting such data. The present disclosure recognizes that the use of the data in the training and predicting processes of the first ML model 208A and the second ML model 208B can be used to benefit users.

For example, the data can be used to train models that can be deployed to improve performance, accuracy, and/or functionality of applications and/or services. Accordingly, the use of the data enables the training and predicting processes of the first ML model 208A and the second ML model 208B to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the training and predicting processes of the first ML model 208A and the second ML model 208B are also contemplated by the present disclosure.

The present disclosure contemplates that, in some embodiments, data used by the training and predicting processes of the first ML model 208A and the second ML model 208B include publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with the training and predicting processes of the first ML model 208A and the second ML model 208B, should attempt to comply with well-established privacy policies and/or privacy practices.

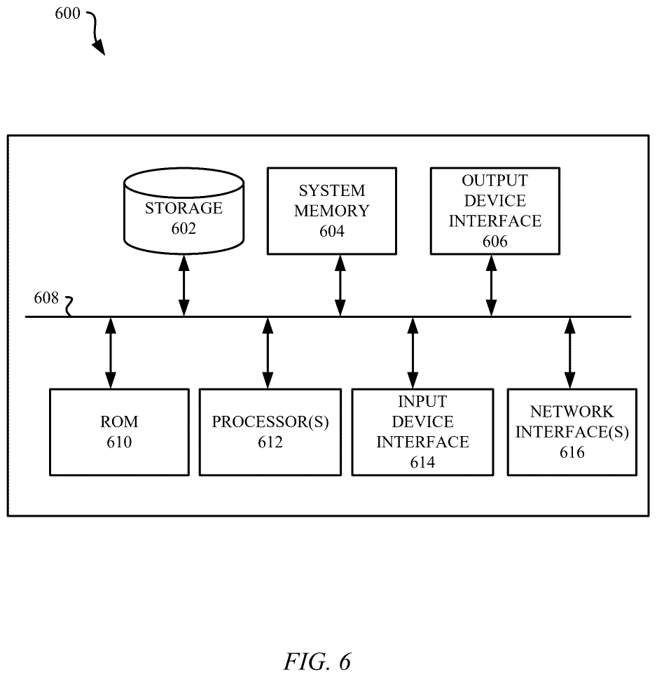

FIG. 6 illustrates an electronic system 600 with which one or more implementations of the subject technology may be implemented. The electronic system 600 can be, and/or can be a part of, the first user device 130, the second user device 140 and the server 150 shown in FIG. 1. The electronic system 600 may include various types of computer readable media and interfaces for various other types of computer readable media. The electronic system 600 includes a bus 608, one or more processing unit(s) 612, a system memory 604 (and/or buffer), a ROM 610, a permanent storage device 602, an input device interface 614, an output device interface 606, and one or more network interfaces 616, or subsets and variations thereof.

The bus 608 collectively represents all system, peripheral, and chipset buses that communicatively connect the numerous internal devices of the electronic system 600. In one or more implementations, the bus 608 communicatively connects the one or more processing unit(s) 612 with the ROM 610, the system memory 604, and the permanent storage device 602. From these various memory units, the one or more processing unit(s) 612 retrieves instructions to execute and data to process in order to execute the processes of the subject disclosure. The one or more processing unit(s) 612 can be a single processor or a multi-core processor in different implementations.

The ROM 610 stores static data and instructions that are needed by the one or more processing unit(s) 612 and other modules of the electronic system 600. The permanent storage device 602, on the other hand, may be a read-and-write memory device. The permanent storage device 602 may be a non-volatile memory unit that stores instructions and data even when the electronic system 600 is off. In one or more implementations, a mass-storage device (such as a magnetic or optical disk and its corresponding disk drive) may be used as the permanent storage device 602.

In one or more implementations, a removable storage device (such as a floppy disk, flash drive, and its corresponding disk drive) may be used as the permanent storage device 602. Like the permanent storage device 602, the system memory 604 may be a read-and-write memory device. However, unlike the permanent storage device 602, the system memory 604 may be a volatile read-and-write memory, such as random-access memory. The system memory 604 may store any of the instructions and data that one or more processing unit(s) 612 may need at runtime. In one or more implementations, the processes of the subject disclosure are stored in the system memory 604, the permanent storage device 602, and/or the ROM 610. From these various memory units, the one or more processing unit(s) 612 retrieves instructions to execute and data to process in order to execute the processes of one or more implementations.

The bus 608 also connects to the input and output device interfaces 614 and 606. The input device interface 614 enables a user to communicate information and select commands to the electronic system 600. Input devices that may be used with the input device interface 614 may include, for example, alphanumeric keyboards and pointing devices (also called “cursor control devices”). The output device interface 606 may enable, for example, the display of images generated by electronic system 600. Output devices that may be used with the output device interface 606 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 6, the bus 608 also couples the electronic system 600 to one or more networks and/or to one or more network nodes through the one or more network interface(s) 616. In this manner, the electronic system 600 can be a part of a network of computers (such as a LAN, a wide area network (“WAN”), or an Intranet, or a network of networks, such as the Internet. Any or all components of the electronic system 600 can be used in conjunction with the subject disclosure.

Implementations within the scope of the present disclosure can be partially or entirely realized as computer program products comprising code in a tangible computer-readable storage medium (or multiple tangible computer-readable storage media of one or more types) encoding one or more instructions of the code. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or segmented in a different way) all without departing from the scope of the subject technology.

Aspects of the present technology may include the gathering and use of data available from specific and legitimate sources to train machine learning models and to apply to trained machine learning models deployed in systems. The present disclosure contemplates that in some instances, this gathered data may include personal information data that uniquely identifies or can be used to identify a specific person. Such personal information data can include meta-data or other data associated with images that may include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to train a machine learning model for better performance. Accordingly, use of such personal information data enables users to have greater control of the delivered content. Further, other uses for personal information data that benefit the user are also contemplated by the present disclosure.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of training data collection, the present technology can be configured to allow users to select to “opt in” or “opt out” of participation in the collection of personal information data during registration for services or anytime thereafter. In another example, users can select not to provide mood-associated data for use as training data. In yet another example, users can select to limit the length of time mood-associated data is maintained or entirely block the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, training data can be selected based on aggregated non-personal information data or a bare minimum amount of personal information, such as the content being handled only on the user's device or other non-personal information available to as training data.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can be integrated together in a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation, or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A computer-implemented method, comprising:
determining, by a first device at a first time, an expected location of a second device at a second time;
identifying, by the first device, cellular connection information for connecting to a cellular base station at the expected location of the second device at the second time; and
transmitting, by the first device, the cellular connection information for connecting to the cellular base station at the expected location.

2. The computer-implemented method of claim 1, wherein the expected location differs from a current location of the first device.

3. The computer-implemented method of claim 2, wherein the cellular base station is different from another cellular base station that the first device is connected to at the current location.

4. The computer-implemented method of claim 1, wherein determining the expected location of the second device at the second time comprises:
selecting, by the first device, a plurality of contextual information associated with a user of the first device that is available at the first time;
processing, by the first device, the plurality of contextual information using a first machine learning (ML) model trained to generate the expected location of the second device at the second time.

5. The computer-implemented method of claim 1, wherein identifying the cellular connection information for connecting to the cellular base station comprises:
processing, by the first device, the expected location of the second device and the second time using a second ML model trained to generate a predicted quality of a set of cellular frequencies emitted by the cellular base station at the expected location;
identifying, by the first device, a subset from the set of cellular frequencies based in part on the predicted quality of the set of cellular frequencies.

6. The computer-implemented method of claim 5, wherein the predicted quality of the set of cellular frequencies comprises at least one of a predicted signal strength, a predicted congestion, or a predicted noise level of each cellular frequency in the set of cellular frequencies.

7. The computer-implemented method of claim 5, wherein the cellular connection information identifies the subset of cellular frequencies.

8. The computer-implemented method of claim 5, wherein transmitting the cellular connection information comprises transmitting, by the first device to the second device, the cellular connection information prior to the second time.

9. A system, comprising:
a processor; and
a memory device containing instructions which, when executed by the processor, cause an application process to:
determine, by a first device at a first time, an expected location of a second device at a second time;
identify, by the first device, cellular connection information for connecting to a cellular base station at the expected location of the second device at the second time; and
transmit, by the first device, the cellular connection information for connecting to the cellular base station at the expected location.

10. The system of claim 9, wherein the expected location differs from a current location of the first device.

11. The system of claim 10, wherein the cellular base station is different from another cellular base station that the first device is connected to at the current location.

12. The system of claim 9, wherein determining the expected location of the second device at the second time comprises:
selecting, by the first device, a plurality of contextual information associated with a user of the first device that is available at the first time;
processing, by the first device, the plurality of contextual information using a first machine learning (ML) model trained to generate the expected location of the second device at the second time.

13. The system of claim 9, wherein identifying the cellular connection information for connecting to the cellular base station comprises:
processing, by the first device, the expected location of the second device and the second time using a second ML model trained to generate a predicted quality of a set of cellular frequencies emitted by the cellular base station at the expected location;
identifying, by the first device, a subset from the set of cellular frequencies based in part on the predicted quality of the set of cellular frequencies.

14. The system of claim 13, wherein the predicted quality of the set of cellular frequencies comprises at least one of a predicted signal strength, a predicted congestion, or a predicted noise level of each cellular frequency in the set of cellular frequencies.

15. The system of claim 13, wherein the cellular connection information identifies the subset of cellular frequencies.

16. The system of claim 13, wherein transmitting the cellular connection information comprises transmitting, by the first device to the second device, the cellular connection information prior to the second time.

17. A non-transitory machine-readable medium comprising instructions that, when executed by one or more processors, cause the one or more processors to perform operations comprising:
determining, by a first device at a first time, an expected location of a second device at a second time;
identifying, by the first device, cellular connection information for connecting to a cellular base station at the expected location of the second device at the second time; and
transmitting, by the first device, the cellular connection information for connecting to the cellular base station at the expected location.

18. The non-transitory machine-readable medium of claim 17, wherein the operations of determining the expected location of the second device at the second time comprises:
selecting, by the first device, a plurality of contextual information associated with a user of the first device that is available at the first time;
processing, by the first device, the plurality of contextual information using a first machine learning (ML) model trained to generate the expected location of the second device at the second time.

19. The non-transitory machine-readable medium of claim 17, wherein the operations of identifying the cellular connection information for connecting to the cellular base station comprises:
processing, by the first device, the expected location of the second device and the second time using a second ML model trained to generate a predicted quality of a set of cellular frequencies emitted by the cellular base station at the expected location;
identifying, by the first device, a subset from the set of cellular frequencies based in part on the predicted quality of the set of cellular frequencies.

20. The non-transitory machine-readable medium of claim 19, wherein the predicted quality of the set of cellular frequencies comprises at least one of a predicted signal strength, a predicted congestion, or a predicted noise level of each cellular frequency in the set of cellular frequencies.
